(19) United States
(12) Patent Application Publication
(10) Pub. No.: US 2018/0089768 A1
(43) Pub. Date: Mar. 29, 2018

(54) FRIEND RECOMMENDATION METHOD

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN); Inventec Appliances (Nanchang) Corporation, Jiangxi (CN)

(72) Inventors: Xiao-Long XU, Jiangxi (CN); Chao ZHOU, Jiangxi (CN); Ju-Nan CHANG, Jiangxi (CN)

(21) Appl. No.: 15/712,163

(22) Filed: Sep. 22, 2017

(30) Foreign Application Priority Data
Sep. 23, 2016 (CN) 201610844598.1

(51) Int. Cl. G06Q 50/00; A63B 24/00

(52) U.S. Cl. CPC G06Q 50/01; A63B 2024/0025; A63B 24/0021; A63B 24/0062

(57) ABSTRACT

A friend recommendation method includes the following operations: first clustering a target user to determine at least one initial to-be-recommended friend list where the target user is located according to several exercise time vectors, several exercise space vectors, and several exercise type vectors of a preset number of a plurality of users in a network; and second clustering the target user to determine a final to-be-recommended friend list where the target user is located according to an exercise intensity vector and an exercise effect vector of each of several users in the at least one initial to-be-recommended friend list.

### CROSS-REFERENCE TO RELATED APPLICATION

This application claims the priority benefit of China Application serial no. 201610844598.1, filed Sep. 23, 2016, the full disclosure of which is incorporated herein by reference.

### FIELD OF INVENTION

The invention relates to a friend recommendation method. More particularly, the invention relates to a friend recommendation method of the Internet information technology.

### BACKGROUND

Social networking has gradually replaced the traditional information access pipeline with the popularity of Internet users, such as Facebook, Weibo, and so on. People publish the information they want to express by sending a message and status. Of course, personal energy is limited, it is impossible for people to find through the Internet by them, and then manually focus on all the contents or nodes that may be interested in. Therefore, the Internet information service providers need to study how to effectively recommend the contents or nodes that the users may be interested in to the users.

Many people in real life like exercise, such as walking, running, riding However, perhaps there is no friend that is suitable for one by his side. Even if people have the same interests, for example, like to walk slowly, they may not be able to go exercise together because the exercise time and location are conflicted. It is also possible that although the exercise time and the location are fitted, but because of different intensity of exercise, for example, a person may walk more than 100,000 steps a day, while another person may only take 10,000 steps per day, which is not appropriate, and the two may not go exercise together.

Therefore, how to effectively recommend friends according to similarities of exercise laws are problems to be improved in the field.

### SUMMARY

A friend recommendation method includes the following operations: first clustering a target user to determine at least one initial to-be-recommended friend list where the target user is located according to several exercise time vectors, several exercise space vectors, and several exercise type vectors of a preset number of a plurality of users in a network; and second clustering the target user to determine a final to-be-recommended friend list where the target user is located according to an exercise intensity vector and an exercise effect vector of each of several users in the at least one initial to-be-recommended friend list.

The beneficial effect of the present disclosure is that first filtering users with similar exercise time, exercise space, and the exercise type to form the initial to-be-recommended friend list, and further second filtering users with similar exercise intensity and exercise effect to form the final to-be-recommended friend list. Through two times of filtering, users with similar laws of exercise have the opportunity to get together, and to become good friends to go exercising together.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flow chart illustrating a friend recommendation method according to some embodiments of the present disclosure.

FIG. 2 is a schematic diagram illustrating a target user exercise trajectory range according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

In the present disclosure, each user ui corresponds to an n-dimensional vector, and each dimension corresponds to an exercise vector. Specifically, each ui corresponds to a five-dimensional vector in the present disclosure: (Vi1, Vi2, Vi3, Vi4, Vi5,). Vi1 denotes the exercise time vector, Vi2 denotes the exercise space vector, Vi3 denotes the exercise form vector, Vi4 denotes the exercise intensity vector, and Vi5 denotes the exercise effect vector. The first filtering of similar exercise time, exercise space, and the exercise type of the users to form the initial to-be-recommended friend list, and further second filtering of similar exercise intensity and exercise effect of the users to form the final to-be-recommended friend list.

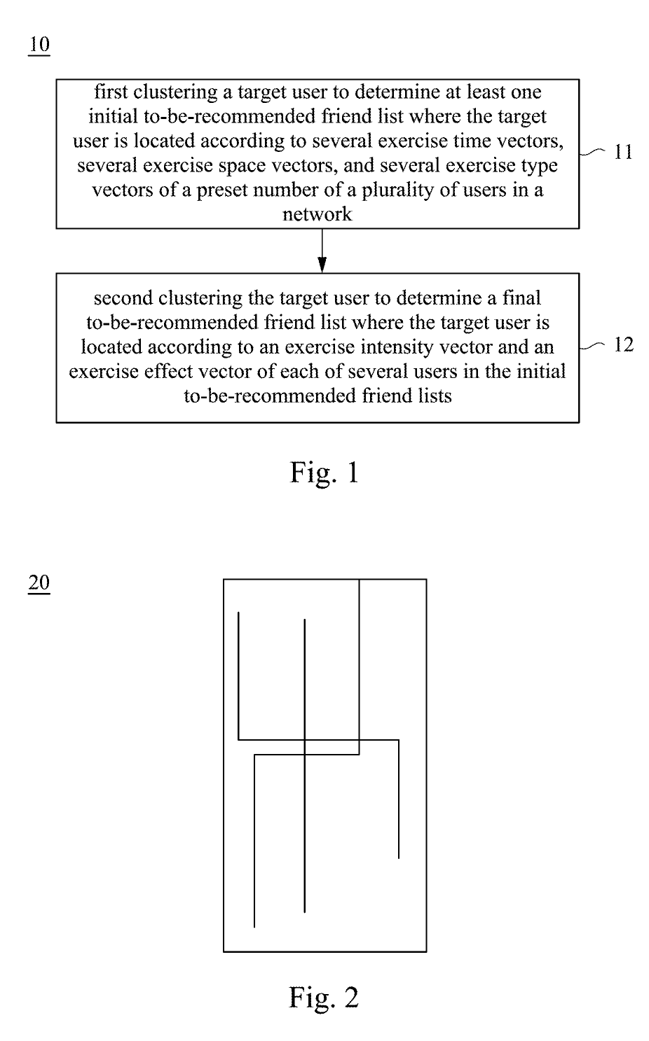

A flow chart of a friend recommendation method 10 provided in the present disclosure is shown in FIG. 1. The friend recommendation method 10 includes the following operations:

Operation 11: first clustering a target user to determine at least one initial to-be-recommended friend list where the target user is located according to several exercise time vectors, several exercise space vectors, and several exercise type vectors of a preset number of a plurality of users in a network;

Operation 12: second clustering the target user to determine a final to-be-recommended friend list where the target user is located according to an exercise intensity vector and an exercise effect vector of each of several users in the initial to-be-recommended friend lists.

The exercise type vector includes but is not limited to walking, jogging, riding; the exercise intensity vector includes but is not limited to the target steps number, the achievement rate; the exercise effect vector includes but is not limited to body fat rate, body age, body mass index. The different exercise vectors may be set according to the specific motion, and are not limited to the above.

In order to recommend a good example of the exercise effect to the target user from the final to-be-recommended friend list, after the second clustering of the target user at operation 12, the method further includes the following operation: sequencing the users in the final to-be-recommended friend list according to the exercise effect vector of each of the users in the final to-be-recommended friend list. To be more specific, the operation includes the following operation: calculating a distance from each of the users in the final to-be-recommended friend list to the target user according to the exercise effect vector. When one of the users in the final to-be-recommended friend list is closer to the target user, a sequence of the one of the users in the final to-be-recommended friend list is more forward.

In an achievable embodiment, the operation of first clustering the target user to determine the at least one initial to-be-recommended friend list where the target user is located according to the exercise time vectors, the exercise space vectors, and the exercise type vectors of the preset number of the users in the network includes the following operation: calculating a similarity of the exercise time vectors, the exercise space vectors, and the exercise type vectors between the target user and each of the users in the internet. The target user and the users in the internet with the similarity greater than a first preset threshold are added to a same one of the at least one initial to-be-recommended friend list.

The operation of second clustering the target user to determine the final to-be-recommended friend list where the target user is located according to the exercise intensity vector and the exercise effect vector of each of the users in the at least one initial to-be-recommended friend list includes the following operation: calculating a similarity of the exercise intensity vector and the exercise effect vectors between the target user and each of the users in the at least one initial to-be-recommended friend list, wherein the target user and the users in the at least one initial to-be-recommended friend list with the similarity greater than a second preset threshold are added to a same one of the final to-be-recommended friend list.

In an achievable embodiment, when a preset number of users in the network belong to different communities, the operation of first clustering the target user to determine the at least one initial to-be-recommended friend list where the target user is located according to the exercise time vectors, the exercise space vectors, and the exercise type vectors of the preset number of the users in the network includes the following operations: calculating a plurality of similarities of the exercise time vectors, the exercise space vectors, and the exercise type vectors between the target user and a plurality of users in one of the communities for each of the communities; calculating an average similarity of the similarities between the target user and the users in the one of the communities: and adding the target user with the average similarity greater than a third preset threshold to the one of the communities to form the at least one initial to-be-recommended friend list.

When there are several initial to-be-recommended friend lists, the operation of second clustering the target user to determine the final to-be-recommended friend list where the target user is located according to the exercise intensity vectors and the exercise effect vectors of each of the users in the at least one initial to-be-recommended friend list includes the following operation: calculating a similarity of the exercise intensity vectors and the exercise effect vectors between the target user and each of the users in the initial to-be-recommended friend lists, and adding the target user and the users in the initial to-be-recommended friend lists with the average similarity greater than a fourth preset threshold to the one of the communities.

At this point, the friends recommended method 10 of the present disclosure is completed. The final to-be-recommended friend list and the target users not only have similar exercise space, exercise time and exercise type, but also have similar exercise intensity and exercise effect. The possibility of the users getting to know each other in the real life has achieved to the largest, so as to effectively achieve the result of friend recommendation.

To clarify the present disclosure, the following lists of specific scenarios are described in details.

### First Embodiment

1) Suppose there are 100 members in the network, the target user as a new member. In order to form final to-be-recommended friend list, each user's exercise information is needed to be collected to get each user's multiple exercise vectors.

Specific implementation may be: statistics of 1 month.

Collecting each user's exercise space information, in which may be the trajectory of each user range. Getting each user's exercise trajectories range this month.

If 1, 2, 3, 4, 5, 6 corresponds to point (6,8), point (8,12), point (12,14), point (14,18), point (18,20), point (20,24) of the exercise time respectively, then, collecting the exercise time of each user information to get the number of times that each of the users falls into each time period.

If 1, 2, 3 are used, respectively, to correspond to the exercise type of walking, jogging, and riding, then, collecting the exercise type of each user's information, to get the number of times that each of the users performs different types of exercise.

For the target user, the target user may determine the target user's final to-be-recommended friend list when the target user joins the network by presetting the target user's exercise vector. The exercise information of the target user may be obtained for a period of time, and the final to-be-recommended friend list that the target user is located is determined according to the collected exercise information.

In the present embodiment, the target user exercise trajectories range 20 is as shown in FIG. 2. The exercise time vectors are [(1, 7), (2,2), (3,0), (4,0), (5,3), (6,1)], in which means that in the same month, the number of times of exercise at point (6,8) is 7 times, the number of times of exercise at point (8,12) is 2 times, the number of times of exercise at point (12,14) is 0, and the number of times of exercise at point (14,18) is 0, the number of times of exercise at point (18,20) is 3 times, and the number of times of exercise at point (20,24) is 1 time. The exercise vector is [(1,20), (2,5), (3,0)], indicating that in the same month, the number of walking is 20 times, the number of jogging is 5 times, and the number of times of riding is 0 Times.

For example, the exercise vector for any three users of 100 member users:

User 1: The exercise space vector is expressed as the number of times that the month falls within the target user's trajectory range, and the number of times the same day falls within the target user's trajectory range is counted only once. In the present embodiment, the exercise space vector of the user 1 is 15, indicating that the number of times the user 1 overlaps the target user's trajectory range is 15 within the same month.

The exercise time vectors are [(1,10), (2,0), (3,0), (4,0), (5,3), (6,1)], indicating that in the same month, the number of times of exercise at point (6,8) is 10, the number of times of exercise at point (8,12) is 0, the number of times of exercise at point (12,14) is 0, the number of times of exercise at point (14,18) is 0, the number of times of exercise at point (18,20) is 3, and the number of times of exercise at point (20,24) is 1.

The exercise type vectors are [(1,19), (2,6), (3,0)], indicating that in the same month, the number of walking is 19 times, the number of jogging is 6 times, and the number of riding is 0 time.

User 2: The exercise space vector is expressed as the lumber of times the month has fallen to the target user's trajectory range, and the number of times the same day falls within the target user's trajectory range is counted only once. In the present embodiment, the exercise space vector of the user 2 is 1, indicating that the number of times the user 2 overlaps the target user's trajectory range is one in the same month.

The exercise time vectors are [(1,8), (2,0), (3,0), (4,0), (5,1), (6,0)], indicating that in the same month, the number of times of exercise at point (6,8) is 8, the number of times of exercise at point (8,12) is 0, the number of times of exercise at point (12,14) is 0, the number of times of exercise at point (14,18) is 0, the number of times of exercise at point (18,20) is 1, and the number of times of exercise at point (20,24) is 0.

The exercise type vectors are [(1,10), (2,5), (3,0)], indicating that in the same month, the number of walking is 10 times, the number of jogging is 5 times, and the number of riding is 0 time.

User 3: The exercise space vector is expressed as the number of times that the month falls within the target user's trajectory range, and the number of times the same day falls within the target user's trajectory range is counted only once. In the present embodiment, the exercise space vector of the user 3 is 0, indicating that the number of times the user 3 overlaps the target user's trajectory range is zero within the same month.

The exercise time vectors are [(1,10), (2,0), (3,0), (4,0), (5,3), (6,10)], indicating that in the same month, the number of times of exercise at point (6,8) is 10, the number of times of exercise at point (8,12) is 0, the number of times of exercise at point (12,14) is 0, the number of times of exercise at point (14,18) is 0, the number of times of exercise at point (18,20) is 3, and the number of times of exercise at point (20,24) is 10.

The exercise type vectors are [(1,0), (2,5), (3,10)], indicating that in the same month, the number of walking is 0 times, the number of jogging is 5 times, and the number of riding is 10 time.

Φ1 is the preset first similarity threshold. If the similarity of the exercise time vector, the exercise space vector, and the exercise form vector between the target user and any user in the network is greater than Φ1, it is determined that the target user has a high degree of similarity with the user; otherwise. if the similarity is less than Φ1, it is determined that the target user has a low similarity to the user.

In the present disclosure, the similarity of the exercise time vector, the exercise space vector, and the exercise type vector between the user 1 and the target user is calculated, the similarity is larger than Φ1, and the target user is determined to have a high similarity with the user 1. The similarity of the exercise time vector, the exercise space vector, and the exercise type vector between the user 2 and the target user is calculated, the similarity is less than Φ1 and the target user is determined to have a low similarity with the user 2. The similarity of the exercise time vector, the exercise space vector, and the exercise type vector between the user 3 and the target user is calculated, the similarity is less than Φ1, and the target user is determined to have a low similarity with the user 3, and so on. Traversing 100 member users, the similarity of the exercise time vector, the exercise space vector, and the exercise type vector between the target user and each user is calculated. The target user and the user who has high similarity with the target user are added to the same initial to-be-recommended friend list. Assuming that the initial to-be-recommended friend list includes the target user, with a total of 20 friends.

2) Collecting the exercise intensity information of each user, including the target step number per day, the number of days completing the target per month, that is, the achievement rate, and so on.

Collecting the exercise effect information of each user, including body fat rate, body age, body mass index, and so on.

For information expressed in specific values, such as target step number per day, the achievement rate, the body fat rate, the body age, the body mass index, and the like, are first normalized and then converted to −1,0 and 1.

For exercise intensity, −1 may be used for weak, 0 may be used for general, and 1 may be used for strong.

For body fat rate, a body fat rate greater than 22% is represented by −1, and a body fat rate of 10% to 15% is represented by 0, and a body fat rate of less than 15% is represented by 1.

For the body age, which is related to the exercise intensity, compared with the actual age of more than 5 years old is represented by −1, compared with the actual age is greater than 1 to 5 years old is represented by 0, compared with the actual age of less than 5 years old is represented by 1.

For the body mass index, may be obtained from the body fat and body weight, the index greater than 30 is represented by −1 showing obesity, the index less than 19, or in the range of 25 to 30 is represented by 0 showing slim or partial fat, the index in the range of 19 to 25 is represented by 1 showing in the normal range.

In summary, by quantifying the exercise intensity information and the exercise effect information of each user, the exercise intensity vector and the exercise effect vector of each user are obtained.

In the present embodiment, the target user's exercise intensity vector is 1, indicating that the exercise intensity is strong. The target user's exercise effect vector set is [1,0,1], indicating that the target user's body fat rate is less than 15%, the body age is greater than 1 to 5 years older than the actual age, and the body mass index is in the normal range.

In the initial to-be-recommended friend list, the exercise intensity vector and the exercise effect vector of 19 users are shown in Table 1, except for the target user.

Φ2 is a preset second similarity threshold, and if the similarity of the exercise intensity vector and the exercise effect vector between the target user and any user in the initial to-be-recommended friend list is larger than Φ2, the target user is determined to have high similarity with the user; otherwise, if the similarity is less than Φ2, it is determined that the target user has a low similarity with the user.

TABLE 1

| | exercise | body fat | | body mass | |
|---|---|---|---|---|---|
| user ID | intensity | rage | body age | index | similarity |
| 1 | 1 | 1 | 0 | 1 | high |
| 2 | 0 | 0 | 0 | 1 | high |
| 3 | 0 | 0 | 0 | 0 | low |
| 4 | −1 | 0 | 0 | −1 | low |
| 5 | 1 | 1 | 1 | 1 | high |
| 6 | 1 | 1 | 0 | 1 | high |
| 7 | 1 | 0 | 1 | 1 | high |
| 8 | −1 | −1 | −1 | −1 | low |
| 9 | −1 | −1 | 0 | −1 | low |
| 10 | 0 | 0 | 1 | 1 | high |
| 11 | −1 | 0 | 0 | 0 | low |
| 12 | −1 | −1 | 1 | 1 | low |
| 13 | 1 | 1 | 0 | 1 | high |
| 14 | 0 | 0 | 0 | 1 | high |
| 15 | 0 | 0 | 0 | 0 | low |
| 16 | −1 | 0 | 0 | −1 | low |
| 17 | 1 | 1 | 1 | 1 | high |
| 18 | 1 | 1 | 0 | 1 | high |
| 19 | 1 | 0 | 1 | 1 | high |

It can be seen from Table 1 that 11 users in the initial to-be-recommended friend list have high similarity to the target user, so that the 11 users and target users are added to the final to-be-recommended friend List. The 11 users and the target user not only have similar exercise space, exercise time and exercise form, but also have similar exercise intensity and exercise effect.

It is to be noted that the specific setting of each exercise vector in the present embodiment may be flexibly processed, and are not limited to the above-described case, and it is sufficient to calculate the similarity between the target user and each user to determine the initial to-be-recommended friend list as well as final to-be-recommended friend list, are protected within the scope of this case. The exercise vector may be obtained by hardware bracelet, body fat and other hardware equipment.

3) For the 11 users in the final to-be-recommended friend list, the distance from between the users and the target user are calculated according to the exercise effect vectors. The closer the user is to the target user, the user in the final to-be-recommended friend list has a sequence which is more forward. As a result, the user with good exercise effect in the final to-be-recommended friend list may be recommended to the target user to become the example of exercising.

### Second Embodiment

Assuming that there are 100 member users on the network, and each member user already belongs to different communities, the target user as a new member, to form the final to-be-recommended friend list, it is in need to collect each user's exercise information and get multiple exercise vectors for each user.

1) For any of the communities, calculate the similarity of the exercise time vector, the exercise space vector, and the exercise type vector between the target user and each user in the community;

2) Calculate the average of the similarities between the target user and users in the community;

3) Φ3 is a preset third average similarity threshold, and if the average similarity of the exercise time vector, the exercise space vector, and the exercise type vector between the target user and the users in the community is larger than Φ3, The target user has a high similarity to the community, and the target user may join the community; otherwise, if the average similarity is less than Φ3, the target user is determined to have a low similarity to the community.

4) As there are multiple communities, the number of communities that can be added by the target user may be multiple, that is, the target user belongs to the overlapping community, and the users in these communities have similar exercise time, exercise space, and exercise type to the target user. Each community with a high degree of similarity to the target user is used as an initial to-be-recommended friend list, so that multiple initial to-be-recommended friend lists may be formed.

5) Calculating the similarity of the exercise intensity vector and the exercise effect vector between the target user and each user in each initial to-be-recommended friend list.

6) Φ4 is a preset fourth similarity threshold. If the similarity of the exercise intensity vector and the exercise effect vector between the target user and any user in the initial to-be-recommended friend list is larger than Φ4, the target user is determined to has a high similarity to the user; conversely, if the similarity is less than Φ4, it is determined that the target user has a low similarity to the user.

7) The user with the similarity greater than Φ4 and the target user are added to the same final to-be-recommended friend list.

Thus, the friend recommendation method 10 of the present embodiment has been completed. Among them, the threshold value may be flexibly set according to the specific application.

In summary, the benefits of the present disclosure are:

First, the recommended friends with similar exercise time, exercise trajectory, and exercise type may be gathered together, and those with similar exercise intensity and exercise effect may be recommended friends and may become good friends, and then meet up to go exercising.

Second, by sequencing the users in the final to-be-recommended friend list, friends with good exercise effect may be recommended to become an example.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A friend recommendation method, comprising:
first clustering a target user to determine at least one initial to-be-recommended friend list where the target user is located according to a plurality of exercise time vectors, a plurality of exercise space vectors, and a plurality of exercise type vectors of a preset number of a plurality of users in a network; and
second clustering the target user to determine a final to-be-recommended friend list where the target user is located according to an exercise intensity vector and an exercise effect vector of each of a plurality of users in the at least one initial to-be-recommended friend list.

2. The friend recommendation method of claim 1, wherein after second clustering the target user, the friend recommendation method further comprises:
sequencing a plurality of users in the final to-be-recommended friend list according to the exercise effect vector of each of the users in the final to-be-recommended friend list.

3. The friend recommendation method of claim 2, wherein sequencing the users in the final to-be-recommended friend list according to the exercise intensity vector and the exercise effect vector of each of the users in the final to-be-recommended friend list comprises:
calculating a distance from each of the users in the final to-be-recommended friend list to the target user according to the exercise effect vector, wherein when one of the users in the final to-be-recommended friend list is closer to the target user, a sequence of the one of the users in the final to-be-recommended friend list is more forward.

4. The friend recommendation method of claim 1, wherein first clustering the target user to determine the at least one initial to-be-recommended friend list where the target user is located according to the exercise time vectors, the exercise space vectors, and the exercise type vectors of the preset number of the users in the network comprising:
calculating a similarity of the exercise time vectors, the exercise space vectors, and the exercise type vectors between the target user and each of the users in the internet, wherein the target user and the users in the internet with the similarity greater than a first preset threshold are added to the one of the at least one initial to-be-recommended friend list.

5. The friend recommendation method of claim 4, wherein second clustering the target user to determine the final to-be-recommended friend list where the target user is located according to the exercise intensity vector and the exercise effect vector of each of the users in the at least one initial to-be-recommended friend list comprising:
calculating a similarity of the exercise intensity vector and the exercise effect vectors between the target user and each of the users in the at least one initial to-be-recommended friend list, wherein the target user and the users in the at least one initial to-be-recommended friend list with the similarity greater than a second preset threshold are added to the one of the final to-be-recommended friend list.

6. The friend recommendation method of claim 1, wherein when each of the preset number of the users of the network belong to a different one of a plurality of communities, first clustering the target user to determine the at least one initial to-be-recommended friend list where the target user is located according to the exercise time vectors, the exercise space vectors, and the exercise type vectors of the preset number of the users in the network comprising:
calculating a plurality of similarities of the exercise time vectors, the exercise space vectors, and the exercise type vectors between the target user and a plurality of users in one of the communities for each of the communities;
calculating an average similarity of the similarities between the target user and the users in the one of the communities; and
adding the target user with the average similarity greater than a third preset threshold to the one of the communities to form the at least one initial to-be-recommended friend list.

7. The friend recommendation method of claim 6, wherein when the at least one initial to-be-recommended friend list comprises a plurality of initial to-be-recommended friend lists, second clustering the target user to determine the final to-be-recommended friend list where the target user is located according to the exercise intensity vectors and the exercise effect vectors of each of the users in the at least one initial to-be-recommended friend list comprising:
calculating a similarity of the exercise intensity vectors and the exercise effect vectors between the target user and each of the users in the initial to-be-recommended friend lists, and adding the target user and the users in the initial to-be-recommended friend lists with the average similarity greater than a fourth preset threshold to the one of the communities.

8. The friend recommendation method of claim 1, wherein the exercise type vectors comprise walking, jogging, riding;
wherein the exercise intensity vectors comprise target step numbers and achievement rates;
wherein the exercise effect vectors comprise body fat percentages, body ages, and body mass indexes.
